(19) United States
(12) Patent Application Publication
(10) Pub. No.: US 2025/0118916 A1
(43) Pub. Date: Apr. 10, 2025

(54) System for protecting a cable connector port against external forces and method thereof

(71) Applicant: Transtech Innovations Inc., Varennes (CA)

(72) Inventor: Joel Martin, Varennes (CA)

(21) Appl. No.: 18/908,415

(22) Filed: Oct. 7, 2024

Related U.S. Application Data
(60) Provisional application No. 63/588,621, filed on Oct. 6, 2023.

(51) Int. Cl. H01R 12/91

(52) U.S. Cl. CPC H01R 12/91

(57) ABSTRACT

An impact resistant charging or data cable connection system is provided. The cable connection system comprises an upper portion and a lower portion. The upper portion comprises cavities for receiving a connector of a cable and for limiting side movement of the connector while being connected to a connector port. The lower portion comprises a force absorption system allowing the connector port to pivot or twist when a side force is applied on the said connector port, typically through forces applied on the connector of the cable. The upper portion may comprise protuberances or shapes allowing easy removal of the connector of the cable from the connector port while safeguarding the said connector port from impacts.

### CROSS-REFERENCE TO RELATED APPLICATIONS

The present patent application claims the benefits of priority of U.S. Provisional Patent Application No. 63/588,621, entitled “IMPACT RESISTANT CHARGING OR DATA CABLE CONNECTION SYSTEM”, and filed at the United States Patent and Trademark Office on Oct. 6, 2024, the content of which is incorporated herein by reference.

### FIELD OF THE INVENTION

The present invention generally relates to systems and methods for charging devices or to data ports having an improved resistance. More specifically, the present invention relates to connecting devices adapted to receive a cable connected to a power source or to a data source.

### BACKGROUND OF THE INVENTION

In the realm of systems and methods for charging devices or data ports having an improved resistance, several approaches have been explored to address mechanical stress, shock absorption, and connector security. The attempted approaches typically offer fragmented solutions. Most of the time, the focus is put on the protection of the cable, rather than on the charging device including the port connector and its soldering points.

In the field of printed circuit boards (PCB) designs, some solutions teach the absorption of stress primarily in flexion. However, absorbing energy in flexion can lead to fatigue stress on PCB traces situated closed to the flexion points. Such stress can be more damaging than torsion-based stress where PCB traces are located at or close to the center of the torsion axis.

Furthermore, the handling portion of the cable connectors may have various shapes and dimensions. As such, a narrow handling portion of certain cable connectors creates space between the cable connector itself and a stopper which can damage the port for the connector and/or the PCB soldering when the cable connector receives an external force, such as an impact, shock or human handling. The human handling may be abusive such as vandalism.

There is thus a need for a novel charging or data communication system limiting the impact or damages of external forces being applied to the said system or to the cable itself.

### SUMMARY OF THE INVENTION

The shortcomings of the prior art are generally mitigated by an impact resistant charging or data cable connection system and a method to protect a connection port from external forces.

It shall be understood that the present disclosure refers to a connector port and a port connector interchangeably.

This invention presents a modulable charging system being impact resistant and being easy to maintain. In some aspect of the invention, the system comprises a first PCB containing one or more port connectors, also referred as a Port PCB, and a second PCB connected to a power source, also referred as a Power PCB. The first and second PCBs are connected one to another with a connector, such as a board-to-board connector. The Power PCB may comprise electronic circuits such as a power converter circuit, typically adjustable having a voltage setpoint input signal. The Port PCB may comprise the one or more port connector(s), a plurality of torsion legs per port connector and some electronic components to protect and manage the port and, if necessary, provide signals to the Power PCB such as voltage setpoint. The Port PCB and its components, including the port connector(s), may be simply replaced when its end of life is reached. This Port PCB is integrated to shock-absorption mechanisms and cable movement controls. The present invention generally safeguards against shocks, rotational forces, and excessive cable movement. The system further aims at offering modularity for maintenance, allowing the replacement of specific PCB components without disconnecting the power source. Furthermore, a unique torsion PCB design enhances durability and connectivity on the port connector(s). The system's secure casing ensures long-lasting performance. Overall, the present invention generally aims at enhancing charger connector durability, simplifies maintenance, and improves user experience.

In one aspect of the invention, an impact resistant charging or data cable connection system is provided. The impact resistant charging or data cable connection system generally comprises an upper portion comprising a cavity for receiving a connector of a cable. The cavity comprises side walls limiting pivoting of the connector of the cable when connected to a connector port of the system. The system further comprises a force absorption system allowing the connector port to resiliently twist or pivot upon being impacted by an external force. The force absorption system may be a slit on the Port PCB allowing pivoting along an axis (axis B as illustrated at FIG. 7). The pivoting axis is typically perpendicular to the orientation of the connector port (axis A as illustrated at FIG. 7).

The system further comprises a PCB attachment system allowing the Port PCB to be attached to the system including the Power PCB. The system may further comprise a force separation mechanism stopping the propagation of the force applied from the connector port to other portions of the Port PCB, namely other connector ports.

In another aspect of the invention, a method to protect a connection port from external forces is provided. The method generally comprises, when the connector of a cable being connected to a connector port is pushed sideways, twisting or pivoting a floating portion of the Port PCB to absorb the applied force. The method further comprises limiting the side movement of the connector of the cable to a predetermined number of degrees, such as 7 degrees. The movement may be limited by abutting on side walls 131 of the charging system.

The method may further comprise isolating the force of the impact or of the twisting of the connector of the cable from one connector port to another. The method may further comprise surrounding the connector of the cable with protuberance adapted to absorb the energy from the impact of an external object.

In yet another aspect of the invention, a system for protecting a port for receiving a connector of a cable against external forces applied on the connector of the cable connected to the port is provided. The port is attachable to a structure. The system comprises a printed circuit board (PCB) connected to a power source, a force absorption assembly operatively connecting the port to the PCB comprising a moving mechanism allowing side movement of the cable connector connected to the port in relation to the PCB in response to external forces applied to the cable connector and a cable connector stopper for limiting side movement of the cable connector when connected to the port and at least partially transferring impact energy to the structure and absorbing the impact energy.

The moving mechanism may comprise a pivoting port attachment member allowing pivoting or twisting about an axis in response to the external forces applied to the connector of the cable. The axis of pivoting may be substantially parallel to width of the port.

The cable connector stopper may comprise abutting members limiting the pivoting movement of the connector to a predefined angle. The pivoting movement of the connector may be limited to 7 degrees or less. The system may comprise a cover portion comprising the abutting members. The cover may comprise outer protuberances comprising at least one cavity for receiving the port, the cavity being shaped to match general shapes of fingers of a user.

The moving mechanism may comprise a resilient member pivotally attached to the PCB, wherein the port is mounted to the resilient portion. The moving mechanism may comprise a slit formed in the PCB around the resilient member and allowing pivoting of the resilient member. The cable connector stopper assembly may further comprise a port movement limiting assembly for limiting movement of the resilient members. The port movement limiting assembly may comprise a pair of abutments, each being on one side of the PCB. The system may comprise at least two ports, the port movement limiting assembly may further comprise a force separator limiting that the forces applied to one of the ports be propagated to another of the ports.

The PCB may comprise a first portion having the force absorption assembly and a second portion connected to the power source, the first portion being detachable from the second portion. The first portion may be attached to a cove attached to the structure. The first portion may comprise a first electrical connector and the second portion comprising a second electrical connector mating with the first electrical connector.

The system may comprise at least two ports, the moving mechanism independently limiting side movement of each of the ports in relation to the PCB. The moving mechanism may comprise at least two resilient members, each of the ports being mounted to one of the at least two resilient members and each resilient member being pivotally and independently attached to the PCB. The moving mechanism may comprise at least two slits formed in the PCB, each slit being formed around one of the resilient members and allowing independent pivoting of each of the resilient members in relation to the PCB.

The system may be mountable to a public transportation vehicle.

In another aspect of the invention, a method for protecting a port against external forces applied on a connector of a cable connected to the said port is provided. The port being connected to a printed circuit board (PCB). The method comprises isolating lateral movement of the external force applied on the port from the PCB.

The method may further comprise the inserted connector abutting against an abutting member to limit the lateral movement of the port after an impact. The method may further comprise isolating the forces applied on the PCB by the lateral movement of the connector port from another connector port.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become

more readily apparent from the following description, reference being made to the accompanying drawings in which:

FIG. 1 is a perspective view of an embodiment of an impact resistant charging system in accordance with the principles of the present invention.

FIG. 2 is a side elevation view of an embodiment of an upper portion of an impact

resistant charging system in accordance with the principles of the present invention.

FIG. 3 is a top plan view of the upper portion of FIG. 2.

FIG. 4 is top perspective view of the upper portion of FIG. 2.

FIG. 5 is a side view of a longitudinal section of the upper portion of FIG. 2.

FIG. 6 is a side elevation view of a lateral section of the upper portion of FIG. 2.

FIG. 7 is a perspective view of the impact resistant charging system of FIG. 1 shown without an outer casing and shown with an embodiment of two PCBs, a port PCB and a power PCB.

FIG. 8 is a perspective view of an embodiment of Port PCB, comprising slots, connectors and electronic components in accordance with the principles of the present invention.

FIG. 9 is a perspective exploded view of the impact resistant charging system of FIG. 1.

FIG. 10 is a front perspective view of the top portion of FIG. 2 comprising the electronic board of FIG. 8.

FIG. 11 is a rear perspective view of the top portion of FIG. 2 comprising the electronic board of FIG. 8.

### DETAILED DESCRIPTION OF THE INVENTION

A novel impact resistant charging or data cable connection system will be described hereinafter. Although the invention is described in terms of specific illustrative embodiments, it is to be understood that the embodiments described herein are by way of example only and that the scope of the invention is not intended to be limited thereby.

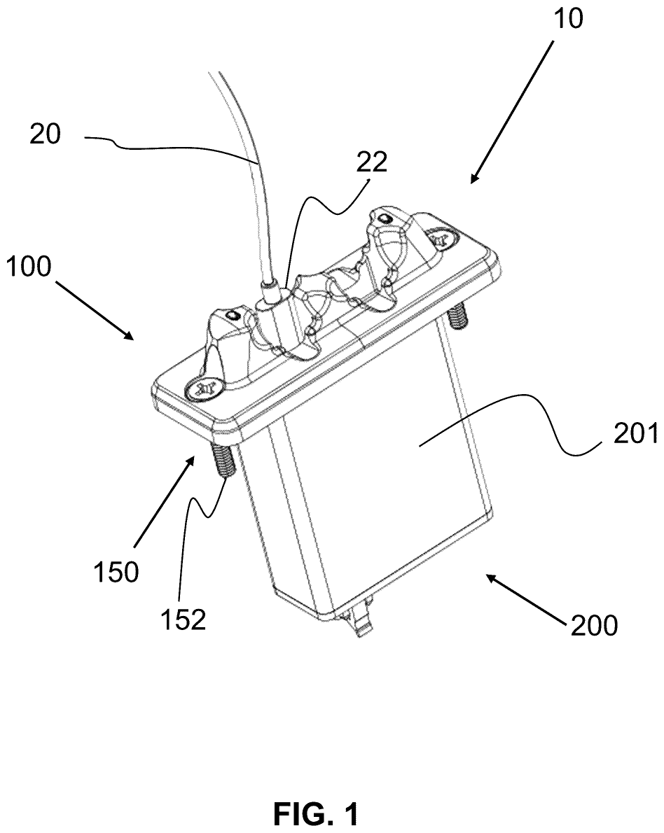

Referring to FIG. 1, an embodiment of an impact resistant charging or data cable

connection system 10 is shown. The charging system 10 is typically installed in public areas such as but not limited to airports, train stations, shopping centers, waiting areas and in transportation means, such as but not limited to bus, planes, trains, ferry, boat, car or any other passenger or commuting vehicle. The charging system 10 may be inserted into an aperture in a wall in a public area. For example, the system 10 may be inserted into an aperture in the transportation means, such as but not limited to a recess of arm rest of a passenger seat. The charging system 10 is connected to a power source or a data source through an input port or power connector. A user may then insert a connector of a cable into a matching connector slot of the charging system 10. The charging system 10 generally aims at resisting to impacts or movements of the connectors of the cable to increase durability of the charging system 10. The charging system 10 may comprise means to abut the connector of the cable and thus to limit angle of movement. The charging system 10 may further comprise flexible areas allowing absorption of any side force being applied on the connector slot and transferred to the electronic board of the charging system 10.

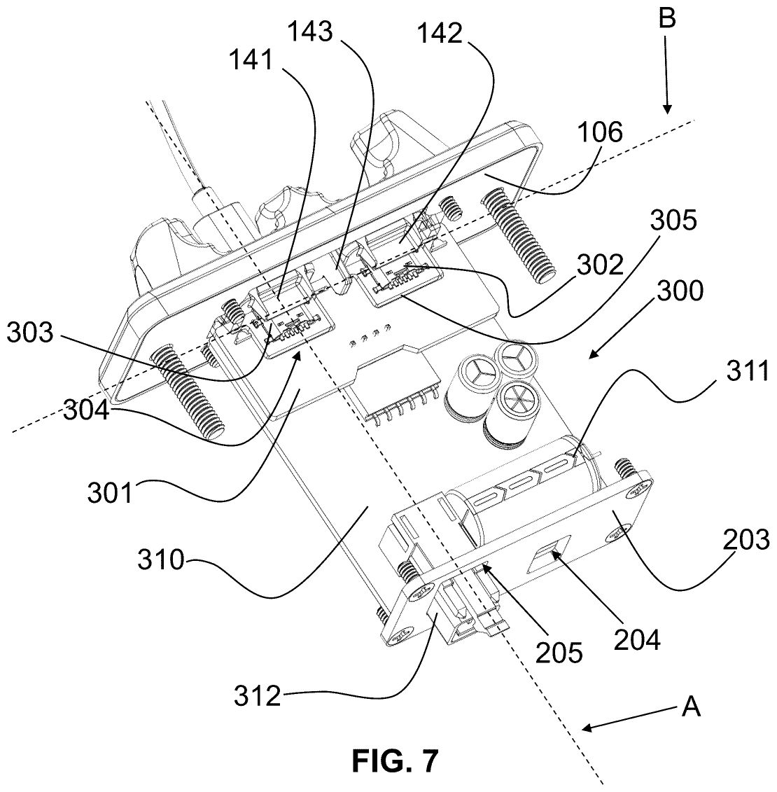

Still referring to FIG. 1, the charging system 10 generally comprises an upper portion 100 adapted to receive the external cable 20 and a lower portion connectable to a power source (not shown) and encasing internal circuitry 300 (shown on FIG. 7) of the charging system 10.

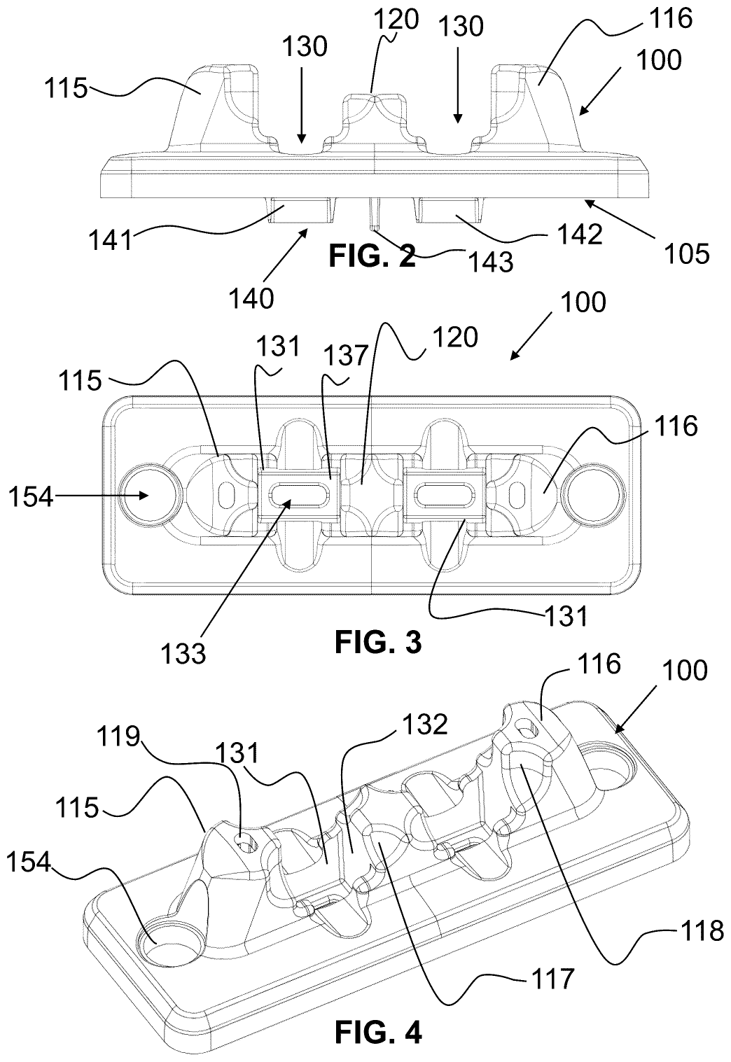

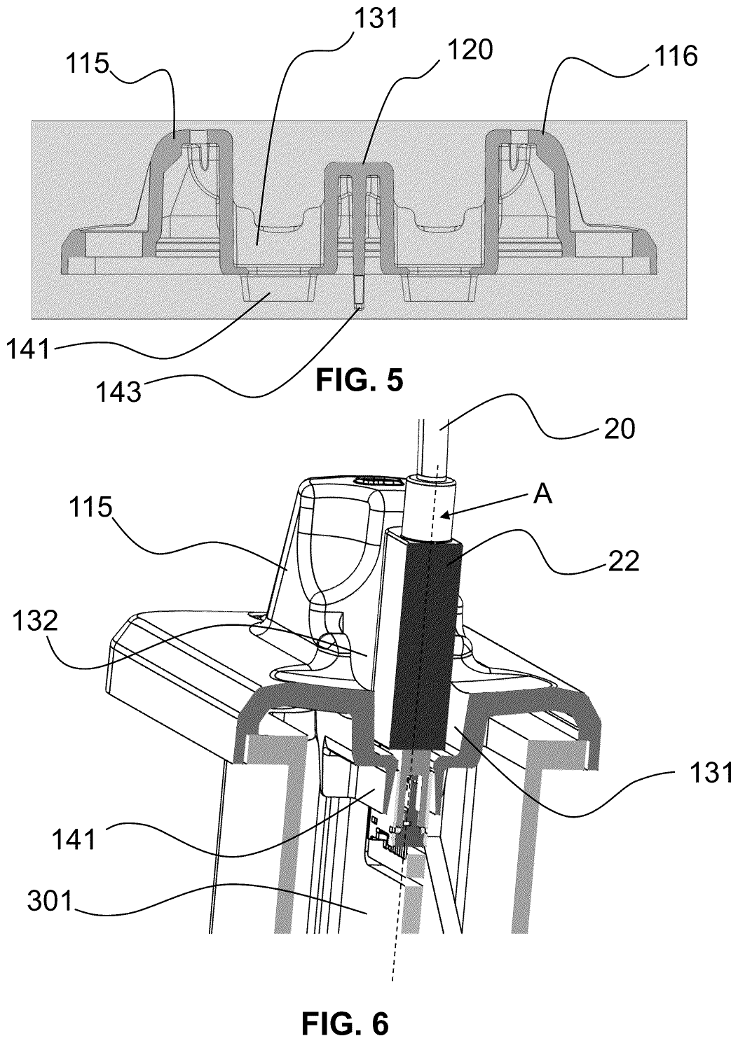

Referring now to FIG. 2-5, an embodiment of the upper portion 100 is illustrated. The upper portion 100 may comprise a case or cover 105. In the illustrated embodiment, the case 105 may be a continuous component comprising protective protuberances 115, 116 and 120 and connector port cavities 130. Understandably, in other embodiments, the case 105 may comprise a plurality of subcomponents. The case 105 is typically made of a hard material, such as hard or semi-hard plastic to absorb and/or transfer the energy of the impact with the surface on which the system 10 is installed.

In the illustrated embodiment, the upper portion 100 comprises two outer protuberances 115 and 116 and a central protuberance 120. The central protuberance is typically positioned between two connector port cavities 130. The protuberances 115, 116 and 120 may be positioned to encase a connector 22 of the cable 20. The protuberances 115, 116 and 120 may be made of solid material. In the illustrated embodiment, the protuberances 115, 116 and 120 are integral with the case 105. The outer protuberances 115 and 116 are typically shaped or comprise a relief aiming at protecting the connector 22 of the cable 20 from impacts when connected to the connector ports 302 or 303.

The protuberances 115 and 116 generally protects the connector 22 (when connected to the connected port 302 and 303) from impacts. As an example, the impacts may be an object, such as but not limited to a bag or luggage, hitting the side of the connector 22, a user pulling the cable 20 at an angle or any other accidental impact on the connector 22 while connected to the system 10.

In some embodiments, the outer protuberances 115 and 116 may comprise cavities or recesses 118. The recesses 118 are typically shaped to match general shapes of fingers, thus aiming to allow a user to safely remove a connector portion 22 of the connected cable 20 without being hindered by the protuberances 115 and116.

Still referring to FIGS. 2-5, the connector port cavities 130 are defined by side walls 131 and by outer walls 132. In the illustrated embodiments, the side walls 131 and outer walls 132 form a cavity having a rectangular base. Understandably, any other shape conforming with a shape of a connector 22 of a cable 20 may be used within the scope of the present invention. In the illustrated embodiment, the two sides walls 131 are positioned to restrict side movement of the connector 22. In the present embodiment, the movement is limited to an angle of about seven degrees with respect to an axis perpendicular to the bottom portion 137 of the cavity 130. Understandably, the distance between the side walls 131 may be changed to limit or increased the allowed angle of movement. In other embodiments, the side walls 131 may be at an angle to further limit the movement of the connector 22. The limitation of movement generally aims at limiting the strain of the connector 22 when receiving a side impact.

The two outer walls 132 are generally vertical. The said outer walls 132 of the connector port cavity 130 may further aim at protecting the connector 22 of the cable 20 and thus the connector ports 302 and 303 when the impact is parallel to the longitudinal axis of the upper portion 100.

The bottom portion 137 of the cavities 130 comprises an aperture or passage 133 allowing the connector 22 of the cable 20 to be inserted in the connector port 302 and 303. The passage 133 is generally shaped to match a horizontal cross-section of the connector 22. The passage 133 is typically larger and wider than the cross-section of the connecting end of the connector 22 to allow rotation and swift passage of the said connecting end but is thinner than the abutting portion of the connector 22 to stop the insertion of the said connector 22.

The system 10 further comprises a port 302 and 303 movement limiting assembly 140. The port movement limiting assembly 140 generally surrounds or is installed on each side of a top portion of the circuit board 300. The port movement limiting assembly 140 creates allowing the connector 101 to slightly pivot and to abut against the said assembly 140, thus absorbing some or all of the force of an impact or an unwanted force on the connector 22. In the illustrated embodiment, the port movement limiting assembly 140 comprises pairs of port abutting portions141 and/or 142 acting as lower stoppers to limit lateral movement of the port 302 or 303. In the illustrated embodiments, the pairs of port abutting portions 141 and 142 extend from the aperture 133 of the cavities 130 and are unitary with the case 105. The pairs of port abutting portions 141 and/or 142 may be made of hard material. The hard material may have resilient properties, such as hard plastics. Each port abutting portion of a pair 141 or 142 are spaced apart enough to allow desired side movement of the port 302 or 303 when pivoted T. In a preferred embodiment, the allowed pivoting angle of allowed by the abutting portion 131 may be similar or equal to the side movement angle allowed by the port abutting portions 131 and/or 142.

The port movement limiting assembly 140 may further comprise a force separator 143. The load separator 143 generally create a rigid connection to avoid any force being applied to a port 302 to be propagated to another port 303. In the illustrated embodiment, the force separator is embodied as tabs or a slot 143. The slot 143 is typically centrally located between the connectors 302 and 303 and is adapted to squeeze or retain a top portion of the circuit board 300. As such, the size of the slot or the distance between the pair of tabs is adjusted in relation to the thickness of the circuit board 300 or the upper PCB board 301, also referred as the port PCB. Understandably, any other mechanism or system to avoid propagation of the force of an impact on a port connector 302 or 303 to the other connector 303 or 302 may be used within the scope of the present invention.

The PCB boards 301 and/or 310 are typically attached to the housing 201. In the present embodiment, a slot (not shown) on an inner portion of the housing 201 slidingly receives the PCB boards 301 and/310 and retains the PCB to the housing 201. The cover 100 is typically attached to the housing 201 using any attachment means, such as but not limited to fasteners, as shown at FIG. 7.

The charging system 10 further comprises mounting means 150. In the illustrated embodiment, the mounting means is embodied as fasteners 152 adapted to be inserted into apertures 154 in the upper portion 100. As such, the fasteners 152 may be any type of known fasteners such as but not limited to bolt, screw or the likes. The apertures may be a screw hole aligned with aperture present on a physical surface to which the charging system 100 is to be attached.

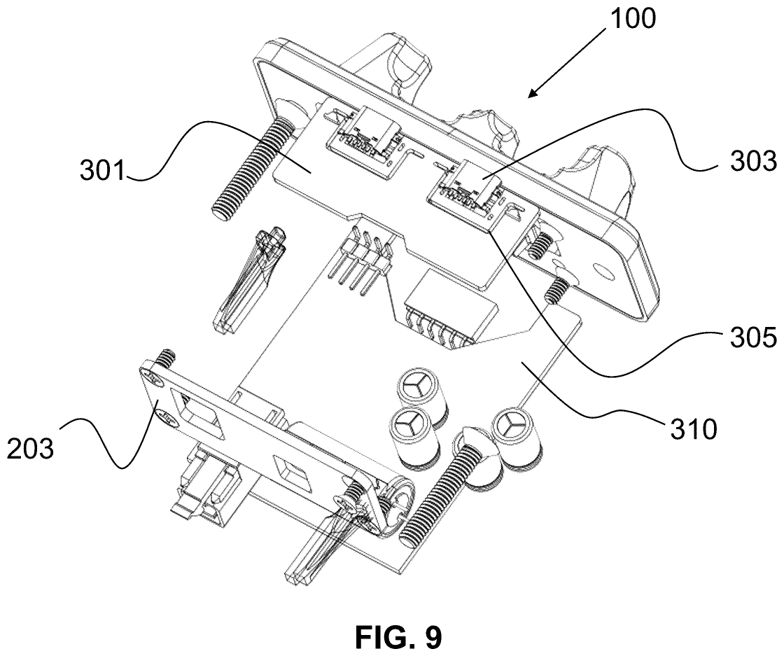

Referring now to FIGS. 7-11, the charging system 10 is illustrated with the internal circuit board 300. The circuit board 300 comprises an upper PCB 301, or port PCB and a lower PCB 310, or power PCB. In some embodiments, the upper PCB 301 may be substantially parallel to the lower PCB 310. The upper PCB 301 is detachably attached to the lower PCB 310 through connectors 307 and 313. The connectors 307 and 313 may be any type of electronic connectors allowing passage of electric signals and current. As such, the upper PCB 301 and the lower PCB 310 may comprise a board-to-board connector allowing easy connection and disconnection of the said PCBs 301 and 310. The connectors 307 and 313 are adapted to remain static when an impact or external forces are applied on the connector of the cable. As such, the connector 313 is preferably mounted to a portion of the upper PCB 301 which does not absorb energy, such as the portion below the slit 305. In the illustrated embodiment, the connector 313 is attached or soldered to the lower PCB 310. Understandably, the upper PCB 301 typically comprises a connector 307 matching the connector 313 on the lower PCB 310.

In embodiments where the upper portion 100 and the attached upper PCB 301 are detachable from the lower portion 200, the upper portion 100 and the attached upper PCB 301 may be replaced by removing fasteners 152 from the surface and pulling the said upper portion 100 and upper PCB 301. The pulling will disconnect the upper PCB 301 from the lower PCB 310. The detachable aspect of the system 10 generally aims at simplifying maintenance or replacement of faulty units or at easing the replacement of obsolete connector ports 302 or 303 having been replaced with more modern connectors or using another communication standard.

As described above, a top portion of the upper PCB 301 is attached or mounted to the upper portion 100 using the attachment system 140. In the illustrated embodiment, the top portion of the upper PCB 301 is maintained between the pairs of tabs 141 and 142.

The upper PCB 301 further comprises one or more connector ports 302 or 303. In the illustrated embodiment, the upper PCB 301 comprises two connector ports 302 and 303. Understandably, in other embodiments, the upper PCB 301 may comprise any number of connector ports 302 or 303.

The upper PCB 301 further comprises a connector force or energy absorption assembly or mechanism 304. The force or energy absorption mechanism 304 generally allows the connector ports 302 and 303 to move or twist about an axis. Such movement allows the connector port 302 or 303 to move without incurring damages to the upper PCB board 301 or to the circuit board 300 in embodiments having unitary upper 301 and lower 310 PCB boards, to the connector ports 302 or 303, or to the connector 22 end of the cable 20. In the illustrate embodiment, the force absorption mechanism 304 is a slit 305. The slit 305 is generally positioned around a bottom portion of the connector port 302 or 303. In the present embodiment, the slit 305 comprise a U-shaped portion 309 circling around the bottom of the connector port 302 or 303 and horizontal portion 317 along the pivoting or twisting axis. The slits 305 are configured to encompass the connector port 302 or 303 so as to absorb shock energy through torsional resistance until the movement limit is reached then the impact energy is transmitted to the case 105 and/or to abutment member 141 or 142. The slits forms pivoting or twisting portion 308 on upper PCB 301. Understandably, the charging system 10 may comprise any number of connectors ports 302 and 303 with their associated absorption mechanism 304. One skilled in the art shall understand that the shape of the slits 305 may be adapted to different shapes of connectors or to provide more or less movement resistance and degrees of rotation or twisting.

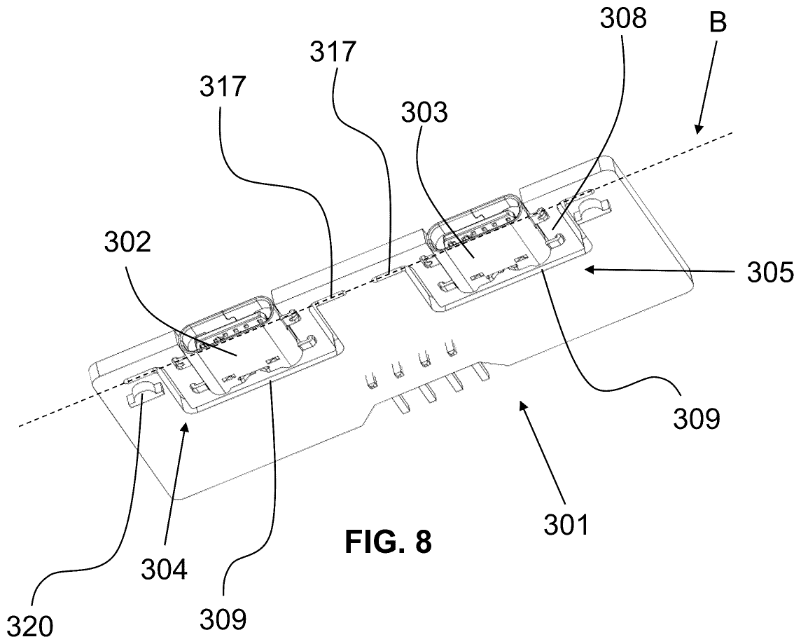

Referring to FIG. 8, the PCB 300, or in in the illustrated embodiment, the port PCB 301, may comprise status lights 320, such as one or more LEDs. The status lights 320 are mounted to a non-moving portion of the PCB 300 to ensure that the lights 320 are always producing the same intensity whether an impact or side movement of the connectors 302 and/or 303 occurs. In some embodiment, the cover 100 may comprise a light tunnel, such as an optic fiber, to propagate the light from the light source 320 an aperture 119 of the cover 100 (see FIG. 4). As illustrated, each of the port 302 and/or 303 may comprise one or more status light 320 and the cover 100 may also comprise an aperture 119 for port 300 of each cavity 130.

In some embodiments, the upper 301 and lower 310 PCB boards may by attached to one another using welding or any other known conductive attachment method.

In yet other embodiments, the upper PCB board 301 may be remotely connected to the lower PCB board 310. In such embodiment, the upper PCB board 301 is in data communication or electrically connected to the lower PCB board 310 through any known method. As an example, the system 10 may comprise a cable connected at one end to the upper PCB board and at another end to the lower PCB board 310. As such, a first compact module comprising the upper board 301 including the connector ports 302 or 303 may be installed at a first location, such as but not limited on a seat or a wall, and a second module comprising the lower PCB board 310 may be located at a further second location. In further embodiment, the system 10 may comprise a central unit adapted to power a plurality of lower PCB board 310, each powering one or more upper PCB board 301. Understandably, any method of remotely powering the upper PCB board 301 from the lower PCB board 310 may be used within the scope of the present invention.

The power PCB 310 is typically connected to a power source in order to convert and deliver electrical power at a setpoint voltage determined remotely by another circuit. As such, the circuit remotely determining the electrical power to be delivered by the power PCB 310 may be present on the port PCB 301.

The connector ports 302 and 303 are fixed to the upper PCB 301 and allows the connector port 302 to electronically transfer information or current to a connected device through a cable 20.

The upper 301 and lower 310 PCBs may comprise a substrate adapted to receive electronic components 311 and power conversion components 312 to allow charging a device or communicating with a device.

Referring now to FIG. 1, an embodiment comprising a housing is illustrated. In such embodiment, the bottom portion 200 comprises a body or housing 201, a bottom portion 203 and an internal circuit board 300. The housing 201 is generally adapted to receive the circuit board 300 and to abut to a bottom portion 106 of the upper portion 100 and to the bottom portion 203. The lower covering surface 203 typically comprises apertures 204 and 205. The aperture 204 comprises a tab adapted for the charging device 10 to be affix to another structure or surface. The aperture 205 is typically shaped to allow passage of a power source connector or port 312. The connector 312 allows the charging device 10 to be powered by any type of electrical power source.

The charging device 10 is typically installed in a transportation means by inserting the bottom portion 200 within a recess matching the shape of the said bottom portion 200. The power connector 312 is connected or inserted in a matching receiving connector of the transportation means. In some embodiments, the upper portion 100 may be split from the lower portion 200. As such, the lower portion 200 is first inserted and the upper portion 100 is then connected to the inserted lower portion 200. The upper portion 100 or case 105 may be mounted to a surface using the attachment system 150. In some embodiment, the fastener 152 is inserted in the screw hole 154 and bolted to a receiving surface.

In use, a connector 22 of a cable 20 is passed through the aperture 133 and is connected to a connector port 302 or 303. When the connector 22 is pushed sideway, the connector port 302 or 303 is twisted as the floating portion 308 of the upper PCB 301 is pivoted along an axis B. In the illustrated embodiment, the axis B is substantially transversal or horizontal. However, in other embodiments, the angle of the axis B shall depend on the alignment of the charging device 10. The pivoting or twisting allows the connector port 302 or 303 to absorb a level of energy limiting the side force applied on the connector port 302 or 303.

The side movement of the connector 22 is further limited by wall 141 of the lower portion 100 and/or by the side wall 131 of the upper portion 100 as the connector 22 abuts on the said side walls 131. In the illustrated embodiment, the side movement of the connector 22 is limited to about 7 degrees about an axis A. In the illustrated embodiment, the axis is substantially transversal or horizontal. As discussed above, in other embodiments, the angle of the axis B shall depend on the alignment of the charging device 10. In embodiments comprising more than one connector ports 302 or 303, the movement is limited to a single connector port 302 or 303. The force of the impact or of the twisting is isolated from one connector port 302 to the other 303.

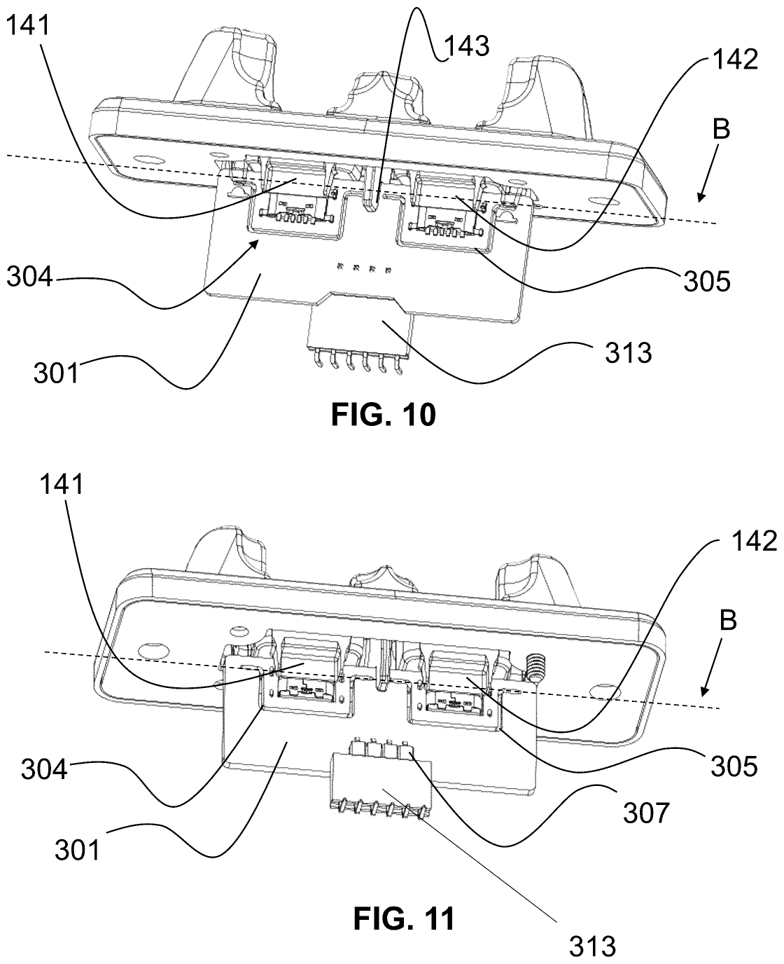

In embodiments comprising protuberances 115 or 116, in use, an impact of an external object is absorbed by the said protuberance creates a barrier around the connector 22 of the cable 20 while connected to the connector port 302 or 303. The protuberances 115 or 116 may be high enough to protect the connector 22 of the cable 20 against impact or shock from objects or humans along the axis B (see FIG. 10 or 11), which is typically along the width of the connector 22. As such, the protuberances 115 or 116 may have a height which is higher than or the same as the height of the connector 22 or of a portion of the cable close to the connector 22.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A system for protecting a port for receiving a connector of a cable against external forces applied on the connector of the cable connected to the port, the port being attachable to a structure, the system comprising:
a printed circuit board (PCB) connected to a power source;
a force absorption assembly operatively connecting the port to the PCB comprising:
a moving mechanism allowing side movement of the cable connector connected to the port in relation to the PCB in response to external forces applied to the cable connector; and
a cable connector stopper for limiting side movement of the cable connector when connected to the port and at least partially transferring impact energy to the structure and absorbing the impact energy.

2. The system of claim 1, the moving mechanism comprising a pivoting port attachment member allowing pivoting or twisting about an axis in response to the external forces applied to the connector of the cable.

3. The system of claim 2, the axis of pivoting being substantially parallel to width of the port.

4. The system of claim 1, the cable connector stopper comprising abutting members limiting the pivoting movement of the connector to a predefined angle.

5. The system of claim 4, the pivoting movement of the connector being limited to 7 degrees or less.

6. The system of claim 4 further comprising a cover portion comprising the abutting members.

7. The system of claim 6, the cover comprising outer protuberances comprising at least one cavity for receiving the port, the cavity being shaped to match general shapes of fingers of a user.

8. The system of claim 1, the moving mechanism comprising a resilient member pivotally attached to the PCB, wherein the port is mounted to the resilient portion.

9. The system of claim 8, the moving mechanism comprising a slit formed in the PCB around the resilient member and allowing pivoting of the resilient member.

10. The system of claim 8, the cable connector stopper assembly further comprising a port movement limiting assembly for limiting movement of the resilient members.

11. The system of claim 10, the port movement limiting assembly comprising a pair of abutments, each being on one side of the PCB.

12. The system of claim 10 comprising at least two ports, the port movement limiting assembly further comprising a force separator limiting that the forces applied to one of the ports be propagated to another of the ports.

13. The system of claim 1, the PCB comprising a first portion having the force absorption assembly and a second portion connected to the power source, the first portion being detachable from the second portion.

14. The system of claim 13, the first portion being attached to a cove attached to the structure.

15. The system of claim 13, the first portion comprising a first electrical connector and the second portion comprising a second electrical connector mating with the first electrical connector.

16. The system of claim 1 comprising at least two ports, the moving mechanism independently limiting side movement of each of the ports in relation to the PCB.

17. The system of claim 16, the moving mechanism comprising at least two resilient members, each of the ports being mounted to one of the at least two resilient members and each resilient member being pivotally and independently attached to the PCB.

18. The system of claim 17, the moving mechanism comprising at least two slits formed in the PCB, each slit being formed around one of the resilient members and allowing independent pivoting of each of the resilient members in relation to the PCB.

19. The system of claim 1 being mountable to a public transportation vehicle.

20. A method for protecting a port against external forces applied on a connector of a cable connected to the said port, the port being connected to a printed circuit board (PCB), the method comprising isolating lateral movement of the external force applied on the port from the PCB.

21. The method of claim 20 further comprising the inserted connector abutting against an abutting member to limit the lateral movement of the port after an impact.

22. The method of claim 21 further comprising isolating the forces applied on the PCB by the lateral movement of the connector port from another connector port.
